(19) United States
(12) Patent Application Publication
(10) Pub. No.: US 2009/0237337 A1
(43) Pub. Date: Sep. 24, 2009

(54) INTEGRATED CIRCUIT DEVICE, ELECTRONIC APPARATUS, AND METHOD FOR SETTING GRAY SCALE CHARACTERISTIC DATA

(75) Inventor: Hiroaki NOMIZO, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/400,535

(22) Filed: Mar. 9, 2009

(30) Foreign Application Priority Data
Mar. 21, 2008 (JP) 2008-073891

(51) Int. Cl. G09G 3/36

(52) U.S. Cl. 345/89; 345/92

(57) ABSTRACT

An electronic apparatus with an electro-optical panel having a plurality of scanning and data lines; an integrated circuit device; a first memory that stores gray scale characteristic data for the electro-optical panel; and a processing section controlling the integrated circuit device and the first memory. The integrated circuit device includes: a scanning driver; a data driver; a second memory storing gray scale data; a gray scale signal generation circuit; and a logic circuit controlling the other elements. The logic circuit retrieves, at a power-on, an initial piece of gray scale characteristic data and then determines whether the retrieved gray scale characteristic data and the given gray scale characteristic data agree or not.

The entire disclosure of Japanese Patent Application No. 2008-73891, filed Mar. 21, 2008 is expressly incorporated by reference herein.

### BACKGROUND

1. Technical Field

An aspect of the present invention relates to an integrated circuit device, an electronic apparatus, and a method for setting gray scale characteristic data.

2. Related Art

Some electronic apparatuses (e.g., electro-optical devices) can include gray scale characteristic data registers (e.g., a gamma-correction data register, a control register, and registers in a control circuit). Refer to the following examples of related art. JP-A-2006-243231 is a first example, JP-A-2003-263134 is a second example, and JP-A-2007-241222 is a third example.

As disclosed in the first example, when an electro-optical device (e.g., a liquid crystal display, an electroluminescence device, a projector, an LED device, and a plasma device) includes a memory (an EEPROM 120 in the first example) storing a plurality of pieces of gray scale characteristic data, the electro-optical device needs to include a gray scale characteristic data register (a first gamma-correction data register 220-1 to a J-th gamma-correction data register 220-j in the first example) retaining all the pieces of the gray scale characteristic data stored in the memory. When the electro-optical device or the gray scale characteristic data register is initialized, all the pieces of the gray scale characteristic data are copied into the gray scale characteristic data register from the memory.

### SUMMARY

Some aspects of the invention are exemplified below. The following aspects are used for readily understanding the invention. It should be noted that those who skilled in the art will be understand the invention is not unduly limited by the following exemplified aspects.

According to a first aspect of the invention, an electronic apparatus includes: an electro-optical panel having a plurality of scanning lines and a plurality of data lines; an integrated circuit device controlling the electro-optical panel; a first memory that stores a plurality of pieces of gray scale characteristic data for the electro-optical panel and is disposed outside the integrated circuit device; and a processing section controlling the integrated circuit device and the first memory. The integrated circuit device includes: a scanning driver driving the plurality of scanning lines; a data driver driving the plurality of data lines; a second memory storing a plurality of pieces of gray scale data; a gray scale signal generation circuit generating a plurality of gray scale signals; and a logic circuit controlling the scanning driver, the data driver, the second memory, and the gray scale signal generation circuit The logic circuit retrieves, at a power-on or a system reset, one of the plurality of pieces of gray scale characteristic data read out from the first memory as gray scale characteristic data for initial setting. The logic circuit determines, at a request for given gray scale characteristic data, whether the gray scale characteristic data for initial setting retrieved in the logic circuit and the given gray scale characteristic data agree or not, and retrieves the given gray scale characteristic data out of the plurality of pieces of gray scale characteristic data read out from the first memory as gray scale characteristic date for rewriting so as to replace the gray scale characteristic data for initial setting with the gray scale characteristic data for rewriting in a case where the given gray scale characteristic data and the gray scale characteristic data for initial setting do not agree. The gray scale signal generation circuit generates the plurality of gray scale signals based on gray scale characteristic data practically retrieved in the logic circuit. The data driver drives one of the plurality of data lines with one of the plurality of gray scale signals, and one of the plurality of pieces of gray scale data stored in the second memory corresponds to the one gray scale signal and the one data line.

In the electronic apparatus, the logic circuit retains only one of the plurality of pieces of gray scale characteristic data stored in the first memory. As a result, an electronic apparatus can be provided in a compact size.

In this case, the memory may store a plurality of control parameters, and one of the plurality of control parameters may correspond to the plurality of pieces of gray scale characteristic data as a gray scale control parameter. The logic circuit may retrieve, at the power-on or the system reset, the plurality of control parameters read out from the first memory excluding the gray scale control parameter, and retrieve one of the plurality of pieces of gray scale characteristic data read out from the first memory as gray scale characteristic data for initial setting. The logic circuit may retrieve, at a request for given refreshing, the plurality of control parameters read out from the first memory excluding the gray scale control parameter, and retrieve one of the plurality of pieces of gray scale characteristic data read out from the first memory as gray scale characteristic data for refreshing, and the gray scale characteristic data for refreshing may correspond to the gray scale characteristic data actually retrieved in the logic circuit.

According to a second aspect of the invention, an integrated circuit device includes: a control register capable of retaining data; and an internal control circuit that acknowledges an instruction from a processing section and controls writing data into the control register. The internal control circuit writes, at a power-on or a system reset, one of a plurality of pieces of gray scale characteristic data read out from a memory into the control register as gray scale characteristic data for initial setting. The internal circuit determines, at a request for given gray scale characteristic data, whether the gray scale characteristic data for initial setting written into the control register and the given gray scale characteristic data agree or not, and writes the given gray scale characteristic data out of the plurality of pieces of gray scale characteristic data read out from the memory into the control register as gray scale characteristic date for rewriting so as to replace the gray scale characteristic data for initial setting with the gray scale characteristic data for rewriting in a case where the given gray scale characteristic data and the gray scale characteristic data for initial setting do not agree.

In the device, the control register retains only one of the plurality of pieces of gray scale characteristic data stored in the memory. As a result, an integrated circuit device can be provided in a compact size.

In this case, the internal control circuit may not write the given gray scale characteristic data into the control register as gray scale characteristic date for rewriting in a case where the given gray scale characteristic data and the gray scale characteristic data for initial setting agree.

In this case, the internal circuit may determine, at a request for second given gray scale characteristic data, whether the gray scale characteristic data practically written in the control register and the second given gray scale characteristic data agree or not, and write the second given gray scale characteristic data of the plurality of pieces of gray scale characteristic data read out from the memory into the control register as the gray scale characteristic date for rewriting so as to replace the gray scale characteristic data practically written with the gray scale characteristic data for rewriting in a case where the second given gray scale characteristic data and the gray scale characteristic data practically written do not agree.

In this case, the memory may store a plurality of control parameters, and one of the plurality of control parameters may correspond to the plurality of pieces of gray scale characteristic data as a gray scale control parameter. The internal control circuit may write, at the power-on or the system reset, the plurality of control parameters read out from the memory excluding the gray scale control parameter into the control register, and write one of the plurality of pieces of gray scale characteristic data read out from the memory into the control register as gray scale characteristic data for initial setting. The internal control circuit may write, at a request for given refreshing, the plurality of control parameters read out from the memory excluding the gray scale control parameter into the control register, and write one of the plurality of pieces of gray scale characteristic data read out from the memory into the control register as gray scale characteristic data for refreshing, and the gray scale characteristic data for refreshing may correspond to the gray scale characteristic data practically written into the control register.

In this case, the integrated circuit device may drive an electro-optical panel based on the gray scale characteristic data practically written into the control register. The internal control circuit may start, at the request for given gray scale characteristic data, writing the given gray scale characteristic data in a non-display period of the electro-optical panel.

In this case, the integrated circuit device may drive an electro-optical panel based on the gray scale characteristic data practically written into the control register. The internal control circuit may start, at the request for given refreshing, writing the plurality of control parameters in a non-display period of the electro-optical panel.

In this case, in a case where the request for gray scale characteristic data conflicts with the request for given refreshing, the internal control circuit may give a higher priority to the request for given gray scale characteristic data than to the request for given refreshing, and start writing the given gray scale characteristic data in the non-display period of the electro-optical panel.

In this case, the integrated circuit device may further include a command register capable of retaining an instruction from the processing section. The internal control circuit, at the request for given gray scale characteristic data, may store, in a first corresponding region in the command register, a memory that the request for given gray scale characteristic data has been inputted. The internal control circuit, at the request for given refreshing, may store, in a second corresponding region in the command register, a memory that the request for given refreshing has been inputted. The internal control circuit may acknowledge that the request for given gray scale characteristic data conflicts with the request for given refreshing in accordance with the memories in the first and the second corresponding regions.

In this case, each of the plurality of pieces of gray scale characteristic data stored in the memory may have a plurality of color components.

According to a third aspect of the invention, a method for setting gray scale characteristic data includes: writing, into a control register in a first mode, a first piece of gray scale characteristic data selected from a plurality of pieces of gray scale characteristic data stored in a memory; and writing, into the control register in a second mode, a second piece of gray scale characteristic data selected from the plurality of pieces of gray scale characteristic data stored in the memory so as to replace the first piece of gray scale characteristic data with the second piece of gray scale characteristic data.

Those who skilled in the art will readily appreciate that the aspects of the invention can be modified without departing the spirit of the invention. For example, at least one element included in an aspect of the invention can be added to another aspect of the invention. Alternatively, at least one element included in an aspect of the invention can be replaced to at least one element included in another aspect of the invention.

### BRIEF DESCRIPTION OF THE DRAWINGS

The invention will be described with reference to the accompanying drawings, wherein like numbers reference like elements.

FIG. 1 is a block diagram showing a structural example of an integrated circuit device.

FIG. 2 is a block diagram showing a structural example of a logic circuit 540 in FIG. 1.

FIG. 3 is an explanatory view illustrating an operational example of an initialize process.

FIG. 4 is an explanatory view illustrating an operational example of a rewrite process.

FIG. 5 is an explanatory view illustrating another operational example of the rewrite process.

FIGS. 6A and 6B are explanatory views illustrating examples of a request for given refreshing.

FIG. 7 is another explanatory view showing another example of the request for given refreshing.

FIG. 8 is another explanatory view showing still another example of the request for given refreshing.

FIG. 9 is an explanatory view illustrating an operational example of a rewrite process and a refresh process.

FIGS. 10A, 10B, and 10C are explanatory views illustrating a rewrite process and /or a refresh process.

FIG. 11 is a block diagram showing a structural example of a gray scale voltage generation circuit 610 in FIG. 1.

### DESCRIPTION OF EXEMPLARY EMBODIMENTS

Hereinafter, embodiments of the invention are described in detail with reference to the accompanying drawings. The embodiments described below do not unduly limit the contents of the invention described in claims. In addition, all the structures described below are not necessarily indispensable structure requirements of the invention.

1. Integrated Circuit Device and Electro-Optical Device

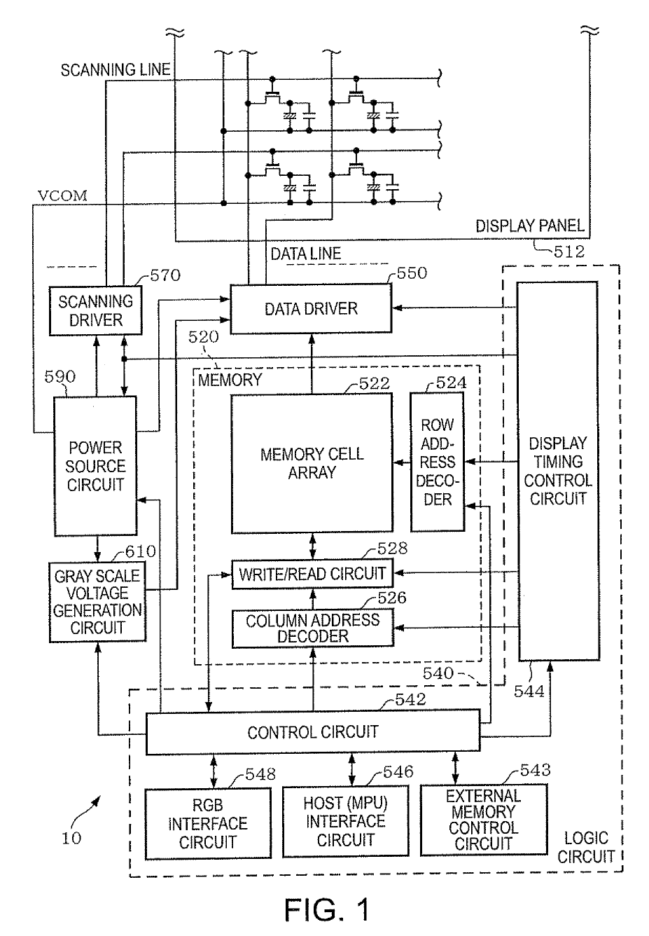

FIG. 1 shows an example of a circuit structure in detail in a case where an integrated circuit device of an embodiment of the invention is a display driver. When an electronic apparatus of another embodiment of the invention is an electro-optical device, the electro-optical device includes an integrated circuit device 10 (display deriver) and an electro-optical panel 512 as shown in FIG. 1. The electro-optical panel 512 is driven by the integrated circuit device 10. The integrated circuit device 10 may omit some of the circuits shown in FIG. 1. The integrated circuit device 10 also may include circuits not shown in FIG. 1.

In FIG. 1, the electro-optical panel 512 includes a plurality of data lines (source lines), a plurality of scanning lines (gate lines), and a plurality of pixels determined by the data lines and the scanning lines. The optical characteristic of an electro-optical element (liquid crystal element, in a narrow sense) is varied in respective pixel regions to realize a display performance. The electro-optical panel 512 can be structured by a panel of an active-matrix type using a switching element such as a thin film transistor (TFT) and a thin film diode (TFD). The electro-optical panel 512 may be a panel of other than the active-matrix type, and also may be a panel of other than the liquid crystal panel. For example, it may be an organic EL panel.

A memory 520 (RAM) stores image data. A memory cell array 522 includes a plurality of memory cells and stores image date (display data) of at least one frame (one screen). The memory 520 includes a row address decoder 524 (MPU/LCD row address decoder), a column address decoder 526 (MPU column address decoder), and a write/read circuit 528 (MPU write/read circuit).

A logic circuit 540 retains gray scale characteristic (y characteristic) data and power source adjustment data. The logic circuit 540 also generates display control signals for controlling display timing, data processing timing, and the like. The logic circuit 540 can be formed by an automatic arrangement and wiring process in a gate array (G/A), for example. A control circuit 542 outputs gray scale characteristic data (γ correction data) for adjusting a gray scale characteristic (γ characteristic) to a gray scale voltage generation circuit 610 (a gray scale signal generation circuit, in a broad sense), and power source adjustment data for adjusting a power source voltage to a power source circuit 590. The control circuit 542 also generates various control signals and controls overall the device. A memory control circuit 543 controls to access an external memory (e.g., EEPROM) coupled to the integrated circuit device 10. For example, the memory control circuit 543 controls reading gray scale characteristic (γ characteristic) data from the external memory to the logic circuit 540. A display timing control circuit 544 generates a signal controlling display timing so as to control reading image data from the memory 520 to the electro-optical panel 512. A host (MPU) interface circuit 546 has an interface function of receiving a signal from a host and sending a signal to the host. Signals between the host and the host (MPU) interface circuit 546 include an inverted chip select signal XCS, a command/data identification signal AO, an inverted read signal XRD, an inverted write signal XWR, an inverted reset signal XRES, and data (commands) D7 to D0 of 8 bits. An RGB interface circuit 548 has an RGB interface function of writing RGB data into the memory 520 at timing provided by a dot clock.

A data driver 550 is a circuit for generating data signals to drive data lines of the electro-optical panel 512. Specifically, the data driver 550 receives gray scale data serving as image data from the memory 520 and a plurality of (e.g., 64 levels) gray scale voltages (reference voltage or gray scale signal in a broad sense) from the gray scale voltage generation circuit 610. The data driver 550 selects a voltage corresponding to the gray scale data out of the plurality of gray scale voltages to output it to the respective data lines of the electro-optical panel 512 as a data signal (data voltage).

A scanning driver 570 is a circuit for generating scanning signals to drive scanning lines of the electro-optical panel 512. Specifically, a signal (enable input-output signal) is sequentially shifted in an internal shift register, and the shifted signal is level-converted to be outputted to the respective scanning lines of the electro-optical panel 512 as a scanning signal (scanning voltage). In this regard, the scanning driver 570 may include a scanning address generation circuit and an address decoder. The scanning address generation circuit may generate a scanning address to output it while the address decoder may decode the scanning address. As a result, a scanning signal may be generated.

The power source circuit 590 generates various power source voltages while the gray scale voltage generation circuit (γ correction circuit) 610 generates the gray scale voltages.

2. Logic Circuit, Micro Processing Unit (MPU), and EEPROM

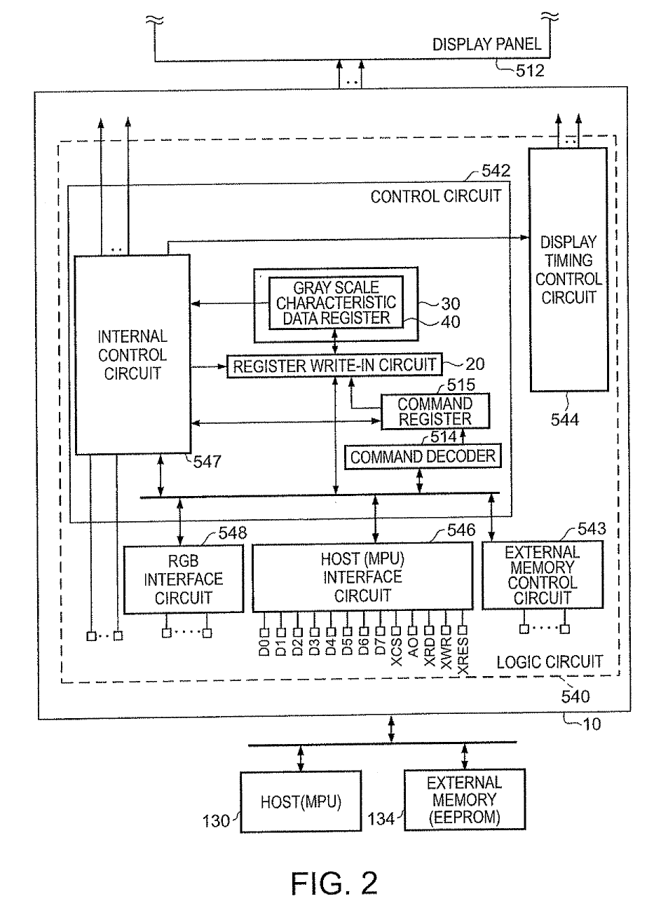

FIG. 2 shows an example of the structure of the logic circuit 540 of FIG. 1 in detail. As shown in FIG. 2, a host (MPU in a narrow sense, or processing unit in a broad sense) 130 and an external memory (EEPROM, or a nonvolatile memory in a narrow sense) 134 are coupled to the integrated circuit device 10. A part or the whole of the integrated circuit device 10, the MPU 130, and the EEPROM 134 may be formed on the electro-optical panel 512 (e.g., on a glass substrate). In FIG. 2, the memory 520, the data driver 550, the scanning driver 570, the power source circuit 590 and the gray scale voltage generation circuit 610 are omitted.

The MPU 130 controls the data driver 550, the scanning driver 570, the power source circuit 590, the gray scale voltage generation circuit 610, and the EEPROM 134. The MPU 130 (processing unit) may be achieved by a universal processor (CPU) or a controller circuit of ASIC. The function of the MPU 130 may be achieved by an external MPU (processing unit) included in electronic apparatuses such as electro-optical devices, cellular phones, pagers, watches, liquid crystal televisions, car navigations, electric calculators, word processors, projectors, and POS terminals.

The logic circuit 540 sets operational mode for and supplies a vertical synchronizing signal as well as a horizontal synchronizing signal to the data driver 550 and the scanning driver 570. The logic circuit 540 also instructs the power source circuit 590 on a power source setting. The logic circuit 540 also instructs the gray scale voltage generation circuit 610 on a gray scale setting. The logic circuit 540 also instructs the EEPROM 134 to access data to be stored therein.

The EEPROM 134 stores various kinds of pieces of information to operate the electro-optical device.

Specifically, the EEPROM 134 stores display characteristic parameters such as contrast adjustment parameters, display control parameters, and gray scale control parameters. The gray scale control parameter can also be referred to as gray scale characteristic data. The EEPROM 134 stores a plurality of pieces of gray scale characteristic data (a plurality of gray scale control parameters).

Liquid crystal devices used for electronic apparatuses such as cellular phones preferably have a plurality of pieces of gray scale characteristic data. For example, when an electronic apparatus displays a still image, the electronic apparatus can select gray scale characteristic data for the still image out of a plurality of pieces of gray scale characteristic data stored in the EEPROM 134. In addition, when an electronic apparatus plays a moving image, the electronic apparatus can select gray scale characteristic data for the moving image out of a plurality of pieces of gray scale characteristic data stored in the EEPROM 134. Further, when an electronic apparatus displays a camera image, the electronic apparatus can select gray scale characteristic data for the camera image out of a plurality of pieces of gray scale characteristic data stored in the EEPROM 134. Thus, the EEPROM 134 stores a plurality of pieces of gray scale characteristic data: GCSET-1 to GCSET-J.

The stored display characteristic control parameters are read out, for example, at a power-on, a system reset, or a refresh request. As for the gray scale control parameters, only one piece of gray scale characteristic data, not the plurality of pieces of gray scale characteristic data read out, is stored in the control circuit 542 ( a control register 30 and a gray scale characteristic data register 40) at the power-on or the system reset. Further, as for the gray scale control parameters, only one piece of gray scale characteristic data selected from the plurality of pieces of gray scale characteristic data is read out at a rewrite request. The read out display characteristic control parameter is stored in the control register 30 (the gray scale characteristic data register 40) at the rewrite request.

The EEPROM 134 also stores control parameters such as power source control parameters (e.g., power source adjustment data), refresh period information, and manufacturing information, in addition to the display characteristic control parameters. The control parameters other than the display characteristic control parameters are read out, for example, at the power-on, the system reset, or the refresh request so as to be stored in the control register 30.

The control register 30 (the gray scale characteristic data register 40) may be achieved by a retaining circuit such as D flip flops, or a memory such as RAM.

3-1. Initialization

When acknowledging a power-on, the MPU 130, for example, conveys the power-on to the MPU interface circuit 546 with an inverted reset signal XRES. An internal control circuit 547 acknowledges the power-on by the inverted reset signal XRES. The inverted reset signal XRES shows “Low” at the power-on, whereas shows “High” at a normal state. When acknowledging a system reset (software reset), the MPU 130 also conveys the system reset to the logic circuit 540 (MPU interface circuit 546 and the internal control circuit 547) with the inverted reset signal XRES. When acknowledging the system reset (software reset), the MPU 130 can also convey the system reset to the logic circuit 540 (the MPU interface circuit 546, a command decoder 514, a command register 515, and the internal control circuit 547) with the command/data identification signal A0, the inverted write signal XWR, and the commands D7 to D0 of 8 bits.

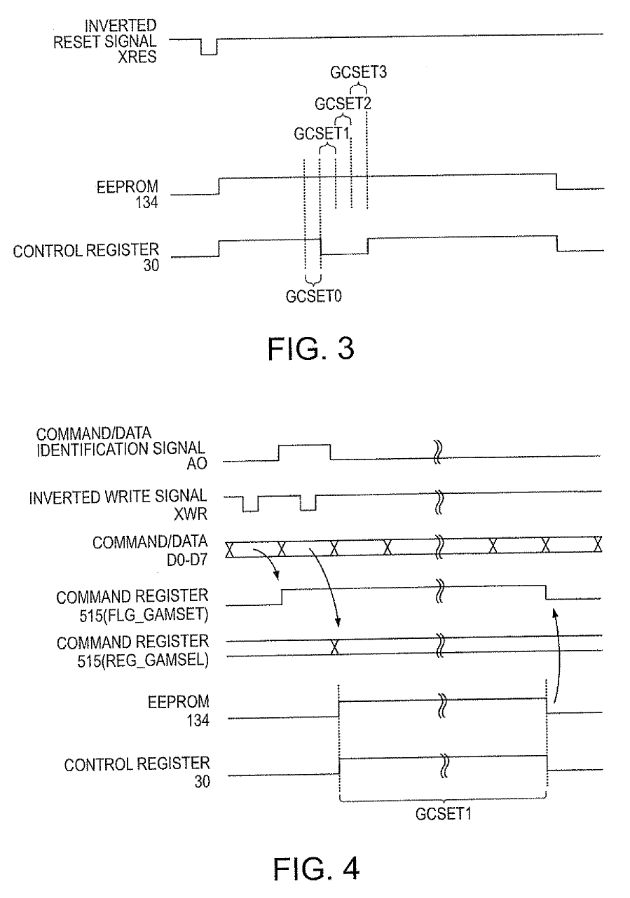

FIG. 3 is an explanatory view showing an operational example of an initialization process. FIG. 3 shows appearances, where the inverted reset signal XRES changes, data is read out from the EEPROM 134, and data is written into the control register 30.

The internal control circuit 547 writes control parameters stored in the EEPROM 134 into the control register 30 at the power-on or the system reset to initialize the control register 30. Specifically, the internal control circuit 547 reads out all the control parameters—from an initial address value to a final address value in the EEPROM 134—through the external memory control circuit 543 at the power-on or the system reset. In an example shown in FIG. 3, the EEPROM 134 stores four pieces of gray scale characteristic data—GCSET-0, GCSET-1,GCSET-2,and GCSET-3—as the gray scale control parameters, and four pieces of gray scale characteristic data —GCSET-0, GCSET-1,GCSET-2, and GCSET-3—are read out.

The internal control circuit 547 writes each of the control parameters other than the gray scale control parameters read out from the EEPROM 134 into respective corresponding regions in the control register 30 (corresponding address value in the control register 30) through a register write-in circuit 20 at the power-on or the system reset. As for the gray scale control parameters read out, only one piece of gray scale characteristic data (e.g., gray scale characteristic data GCSET-0) is written into the corresponding region in the control register 30 (gray scale characteristic data register 40) through the register write-in circuit 20. In the example shown in FIG. 3, only one piece of gray scale characteristic data (one piece of gray scale characteristic data for initial setting) is written into the control register 30.

Referring back to JP-A-2006-243231 (the first example of related art), the gamma correction data registers 220-1 to 220-J shown in FIG. 8 thereof retain all the first gamma correction data to the J-th gamma correction data stored in the EEPROM 120 shown in FIG. 4 thereof. In contrast, the control register 30 (the gray scale characteristic data register 40) of the embodiment retains only one piece of gray scale characteristic data out of the plurality of pieces of gray scale characteristic data stored in the EEPROM 134. As a result, the retaining capacity of the control register 30 can be reduced. In other words, the control register 30 can be downsized.

3-2. Rewrite

When acknowledging a request for given gray scale characteristic data, the MPU 130 conveys the request for given gray scale characteristic data to the logic circuit 540 (the MPU interface circuit 546, the command decoder 514, the command register 515, and the internal control circuit 547) with the command/data identification signal AO, the inverted write signal XWR, and the commands/data D7 to D0 of 8 bits. The command/data identification signal A0 shows “Low” when the data conveyed from the MPU 130 to the logic circuit 540 is a command while shows “High” when the data conveyed from the MPU 130 to the logic circuit 540 is a parameter of a command. The commands/data D7 to D0 of 8 bits show a command or a parameter depending on the command/data identification signal A0. The inverted write signal XWR shows “Low” when the commands/data D7 to D0 of 8 bits are decoded by the logic circuit 540.

FIG. 4 is an explanatory view showing an operational example of a rewrite process. FIG. 4 shows appearances, where the commands/data identification signal AO changes, the inverted write signal XWR changes, the commands/data D7 to D0 changes, data in a corresponding region FLG_GAMSET in the command register 515 is rewritten, data in a corresponding region REG_GAMSEL in the command register 515 is rewritten, data is read out from the EEPROM 134, and data is written into the control register 30.

The internal control circuit 547 determines whether gray scale characteristic data written into the control register 30 (the gray scale characteristic data register 40) and given gray scale characteristic data agree or not at the request for the given gray scale characteristic data. When the given gray scale characteristic data and the written gray scale characteristic data do not agree, the internal control circuit 547 writes given gray scale characteristic data stored in the EEPROM 134 into the control register 30 (the gray scale characteristic data register 40) so as to rewrite the control register 30.

Specifically, the rewrite process is conducted in the following manner, for example.

When both the command/data identification signal AO and the inverted write signal XWR show “Low”, the command decoder 514 decodes the commands/data D7 to D7 of 8 bits (e.g., the commands/data D7 to D2 of upper 6 bits) to acknowledge that the command is for setting gray scale characteristic data (GAMSET). Responding to the decoded result, the command register 515 stores in a corresponding region (FLG_GAMSET) that the command (for setting gray scale characteristic data (GAMSET)) is inputted. When a memory is stored that the command (for setting gray scale characteristic data (GAMSET)) has been inputted into the corresponding region (FLG_GAMSET) in the command register 515, the corresponding region (FLG_GAMSET) in the command register 515 outputs a signal showing “High” to the internal control circuit 547. In this way, the internal control circuit 547 acknowledges the command (for setting gray scale characteristic data (GAMSET)). At the same time, the internal control circuit 547 acknowledges gray scale characteristic data written into the control register 30 (the gray scale characteristic data register 40) through a corresponding region (REG_GAMSEL) in the command register 515. The corresponding region (REG_GAMSEL) in the command register 515 shows, at the power-on or the system reset, one piece of gray scale characteristic data (e.g., GCSET-0) for initial setting.

When the command/data identification signal AO shows “High” and the inverted write signal XWR shows “Low”, the command decoder 514 decodes the commands/data D7 to D0 of 8 bits (e.g., the commands/data D1 and D0 of lower 2 bits) to acknowledge that the parameter of the command is desired gray scale characteristic data (e.g., GCSET-1). The command decoder 514 conveys the decoded result to the internal control circuit 547. The internal control circuit 547 determines whether gray scale characteristic data (e.g., GCSET-0 at refresh) written into the control register 30 (the gray scale characteristic data register 40) and the decoded result (e.g., GCSET-1 at rewrite) agree or not. When the decoded result (e.g., GCSET-1) and the gray scale characteristic data (e.g., GCSET-0) written into the control register 30 do not agree, the internal control circuit 547 acknowledges a request for given gray scale characteristic data. The internal control circuit 547 conveys an enabling signal to the command register 515 at the request for given gray scale characteristic data. The command register 515 stores the parameter of the command (a desired gray scale characteristic data, e.g., GCSET-1) in a corresponding region (REG_GAMSEL) responding to the decoded result and the judgment result (the enabling signal). For example, the corresponding region (REG_GAMSEL) in the command register 515 shows desired gray scale characteristic data (e.g., GCSET-1) in place of one piece of gray scale characteristic data (e.g., GCSET-0) for initial setting.

The internal control circuit 547 reads out given gray scale characteristic data (e.g., GCSET-1) stored in the EEPROM 134 through the external memory control circuit 543 at the request for given gray scale characteristic data. In an example shown in FIG. 4, the EEPROM 134 stores four pieces of gray scale characteristic data—GCSET-0, GCSET-1,GCSET-2,and GCSET-3—as the gray scale control parameters, and only one piece of given gray scale characteristic data (e.g., gray scale characteristic data GCSET-1) is read out.

The internal control circuit 547 writes one piece of gray scale characteristic data read out from the EEPROM 134 into a corresponding region (the gray scale characteristic data register 40) in the control register 30 through the register write-in circuit 20 at the request for given gray scale characteristic data. In the example shown in FIG. 4, only one piece of gray scale characteristic data (one piece of desired gray scale characteristic data) is written into the control register 30.

Upon completion of reading out given gray scale characteristic data (e.g., GCSET-1) stored in the EEPROM 134 and writing the given gray scale characteristic data (e.g., GCSET-1) into the control register 30, the internal control circuit 547 conveys a command (for setting gray scale characteristic data(GAMSET)) completion result to the command register 515. Responding to the command completion result, the command register 515 erases a memory that the command (for setting gray scale characteristic data (GAMSET)) has been inputted into the corresponding region (FLG_GAMSET).

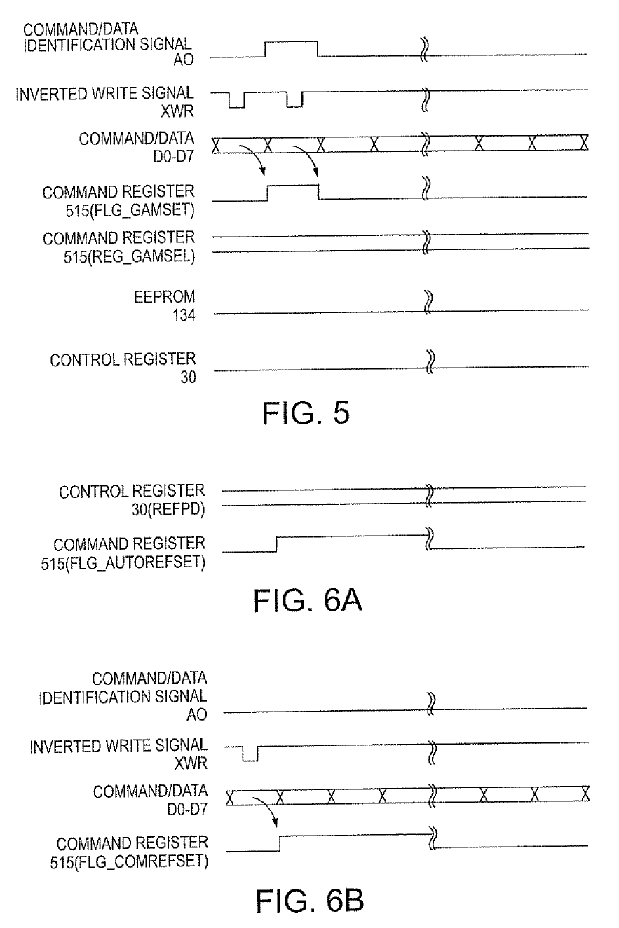

FIG. 5 is an explanatory view showing another operational example of the rewrite process.

When the command/data (given gray scale characteristic data) conveyed from the MPU 130 is one piece of gray scale characteristic data practically retained in the control register 30, the internal control circuit 547 does not conduct the rewrite process. In other words, the internal control circuit 547 does not read out given gray scale characteristic data stored in the EEPROM 134 when the gray scale characteristic data written into the control register 30 (the gray scale characteristic data register 40) and the given gray scale characteristic data agree at the request for given gray scale characteristic data. Responding to the decoded result and the judgment result (no enabling signal), the command register 515 erases a memory that the command (for setting gray scale characteristic data (GAMSET)) has been inputted into the corresponding region (FLG_GAMSET). When a memory is not stored that the command (for setting gray scale characteristic data (GAMSET)) has been inputted into the corresponding region (FLG_GAMSET) in the command register 515, the corresponding region (FLG_GAMSET) in the command register 515 outputs a signal showing “Low” to the internal control circuit 547. In this way, the internal control circuit 547 can ignore the command/data (rewrite request) conveyed from the MPU 130. In this case, the internal control circuit 547 does not conduct an unfruitful rewrite process.

3-3. Refresh Process (Refreshing)

The internal control circuit 547 writes control parameters read out from the EEPROM 134 into the control register 30 at the initialization process. The control parameters include refresh period information and display characteristic control parameters. The display characteristic control parameters include gray scale control parameters (gray scale characteristic data). The internal control circuit 547 writes gray scale control parameters (gray scale characteristic data) read out from the EEPROM 134 into the control register 30 (the gray scale characteristic data register 40) at the rewrite process. For example, in electronic apparatuses such as cellular phones, various external factors such as electrostatic discharge (ESD) occur depending on the usage conditions. If the control parameters set in the control register 30 are changed by the external factors, an optimum display characteristic may not be maintained, for example.

To cope with the problem, the internal control circuit 547 writes the control parameters stored in the EEPROM 134 to the control register 30 to refresh the control register 30 at a request for given refreshing. The request for given refreshing includes a request based on refresh period information written into the control register 30 and another request based on a command conveyed from the MPU 130.

FIGS. 6A and 6B are explanatory views showing examples of the request for given refreshing. FIG. 6A shows a request based on refresh period information written into the control register 30 while FIG. 6B shows another request based on a command conveyed from the MPU 130.

The control register 30 stores the following exemplified refresh period: no refreshing, and 64, 128, 192, and 256 frames. The internal control circuit 547 conveys automatic refresh setting information to the command register 515 based on the refresh period information (excluding no refreshing). As shown in FIG. 6A, responding to the automatic refresh setting information, the command register 515 stores into a corresponding region (FLG_AUTOREFSET) that a refresh request (AUTOREDSET) has been inputted.

When acknowledging the refresh request (command refresh), the MPU 130 conveys the refresh request to the logic circuit 540 (the MPU interface circuit 546, the command decoder 514, the command register 515, and the internal control circuit 547) with the command/data identification signal AO, the inverted write signal XWR, and the commands D7 to D0 of 8 bits. The command decoder 514 decodes the commands/data D7 to D0 (e.g., the commands/data D7 to D2 of upper 6 bits) to acknowledge that the command is the refresh request (COMREFSET). As shown in FIG. 6B, responding to the decoded result, the command register 515 stores into a corresponding region (FLG_COMREFSET) that the command (the refresh request (COMREFSET) has been inputted.

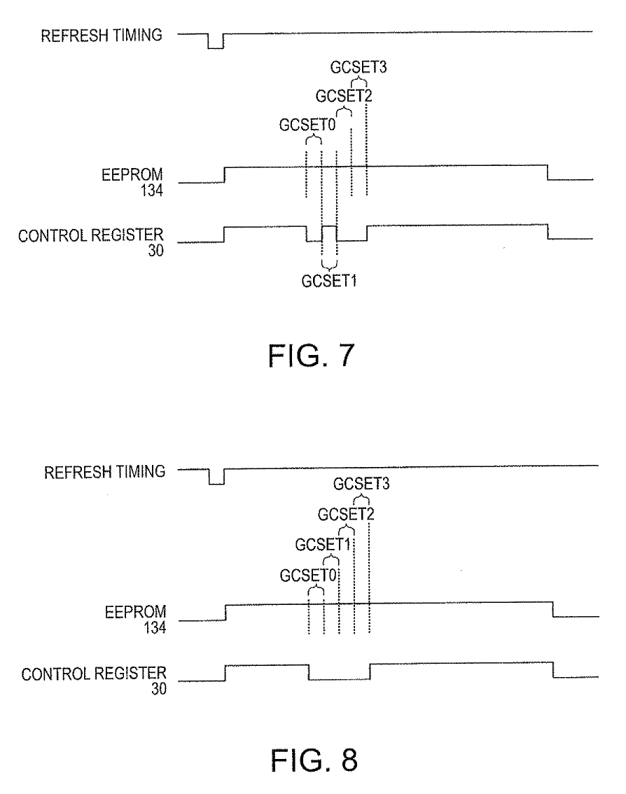

FIG. 7 is another explanatory view showing an example of the request for given refreshing.

The internal control circuit 547 acknowledges a refresh request (AUTOREDSET or COMREFSET) through the command register 515. The internal control circuit 547 reads out all the control parameters—from an initial address value to a final address value in the EEPROM 134—through the external memory control circuit 543 when acknowledging the refresh request. In an example shown in FIG. 7, the EEPROM 134 stores four pieces of gray scale characteristic data—GCSET-0, GCSET-1,GCSET-2,and GCSET-3—as the gray scale control parameters, and four pieces of gray scale characteristic data—GCSET-0, GCSET-1,GCSET-2, and GCSET-3—are read out.

The internal control circuit 547 writes each of the control parameters other than the gray scale control parameters read out from the EEPROM 134 into respective corresponding regions in the control register 30 (corresponding address value in the control register 30) through a register write-in circuit 20 at the request for given refreshing. As for the gray scale control parameters read out, only one piece of gray scale characteristic data (e.g., gray scale characteristic data GCSET-1) is written into the corresponding region in the control register 30 (the gray scale characteristic data register 40) through the register write-in circuit 20. In the example shown in FIG. 7, only one piece of gray scale characteristic data is written into the control register 30.

The one piece of gray scale characteristic data (e.g., gray scale characteristic data GCSET-1) depends on the state of a corresponding region (e.g., REG_GAMSEL) in the command register 515. For example, when a corresponding region (REG_GAMSEL) in the command register 515 continues to show one piece of gray scale characteristic date for rewriting (e.g., GCSET-1) due to a rewrite process after a power-on or a system reset, the internal control circuit 547 writes only the one piece of gray scale characteristic date for rewriting (e.g., GCSET-1) into a corresponding region in the control register 30 (the gray scale characteristic data register 40) at a request for given refreshing. Alternatively, when a corresponding region (REG_GAMSEL) in the command register 515 continues to show one piece of gray scale characteristic date for initial setting (e.g., GCSET-0) due to a initialization process, the internal control circuit 547 writes only the one piece of gray scale characteristic date for initial setting (e.g., GCSET-0) into a corresponding region in the control register 30 (the gray scale characteristic data register 40) at a request for given refreshing.

FIG. 8 is still another explanatory view showing an example of the request for given refreshing.

The internal control circuit 547 may write only the control parameters that are stored in the EEPROM 134 and do not includes gray scale control parameters to the control register 30 to refresh the control register 30 at a request for given refreshing. Writing the read out gray scale control parameters into a corresponding region in the control register 30 (the gray scale characteristic data register 40) may be omitted. In other words, the rewrite process on the gray scale control parameters may be substituted for the refresh process.

4. Rewrite Request and Refresh Request

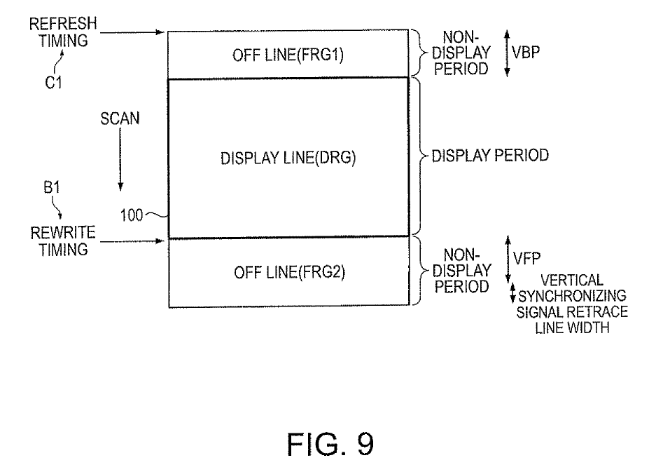

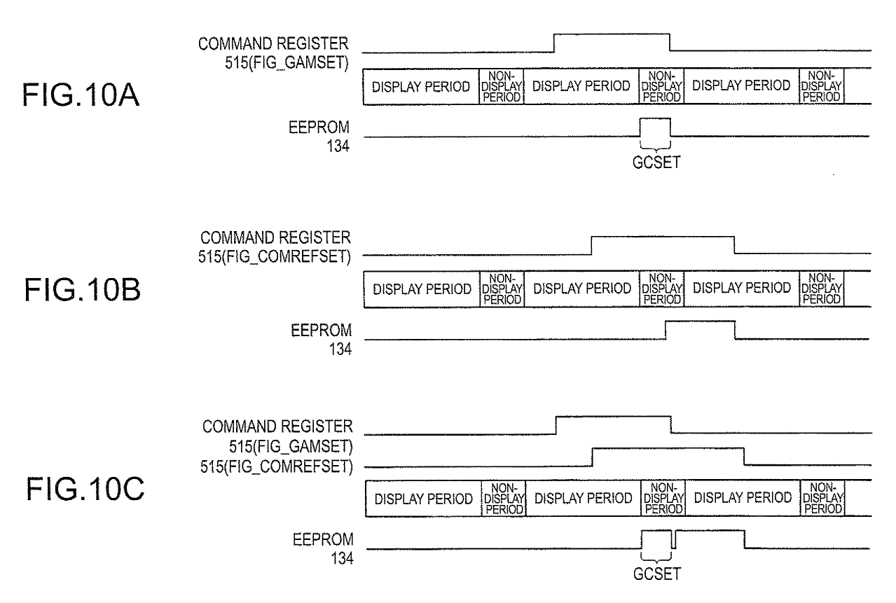

FIG. 9 is an explanatory view showing an operational example of the rewrite process and the refresh process. FIG. 10A is an explanatory view showing the rewrite process. FIG. 10B is another explanatory view showing the refresh process. FIG. 10C is still another explanatory view showing the rewrite and refresh processes.

In the embodiment, the rewrite and refresh processes of the control register 30 are preferably conducted in a non-display period of the display panel 512 (the data driver 550).

Specifically, as shown in FIG. 9 in the embodiment, a display line region GRG and off line (display off line) regions FRG1 and FRG2 are set in the display panel 512.

In the display line region DRG, images are practically displayed. In contrast, no images are displayed in the off line regions FRG1 and FRG2. That is, the regions are dummy regions.

The rewrite process of the control register 30 is preferably conducted in the non-display period (preferably, at the starting time of a vertical front porch (at the starting time of a vertical blanking period)) as shown with a symbol B1 in FIG. 9. As a result, the rewrite process (writing process of gray scale characteristic data) of the control register 30 does not adversely affect display performance. In FIG. 4, if reading out given gray scale characteristic data (e.g., GCSET-1) stored in the EEPROM 134, and writing the given gray scale characteristic data (e.g., GCSET-1) into the control register 30 are scheduled in a display period, the starting of the reading and writing are preferably delayed to the non-display period as shown in FIG. 10A.

In the embodiment, as shown with a symbol C1 in FIG. 9, the refresh process of the control register 30 is conducted in the non-display period (preferably, at the starting time of a vertical back porch) of the display panel 512. As a result, the refresh process (writing process of display characteristic control parameters other than gray scale control parameters (gray scale characteristic data)) of the control register 30 does not adversely affect display performance. In FIG. 7 or 8, if reading out control parameters stored in the EEPROM 134, and writing control parameters into the control register 30 are scheduled in a display period, the starting of the reading and writing are preferably delayed to the non-display period as shown in FIG. 10B. In FIG. 10B, the starting of the reading and writing may be changed from the starting time of the vertical back porch to that of the vertical front porch, or/and the periods of reading and the writing may be changed from one non-display period and one display period to only a plurality of non-display periods.

In the embodiment, as shown in FIG. 10C, if the rewrite process and the refresh process conflict in a non-display period, the refresh process is conducted after the rewrite process. If the control parameters set by the control register 30 is less likely changed by external factors, the rewrite process conducted prior to the refresh process does not likely adversely affect the display performance in the rewrite process. In FIG. 10C, the starting of the refresh process may be delayed to the subsequent non-display period or only the refresh process conflicting with the rewrite process may be omitted.

5. Gray Scale Voltage Generation Circuit

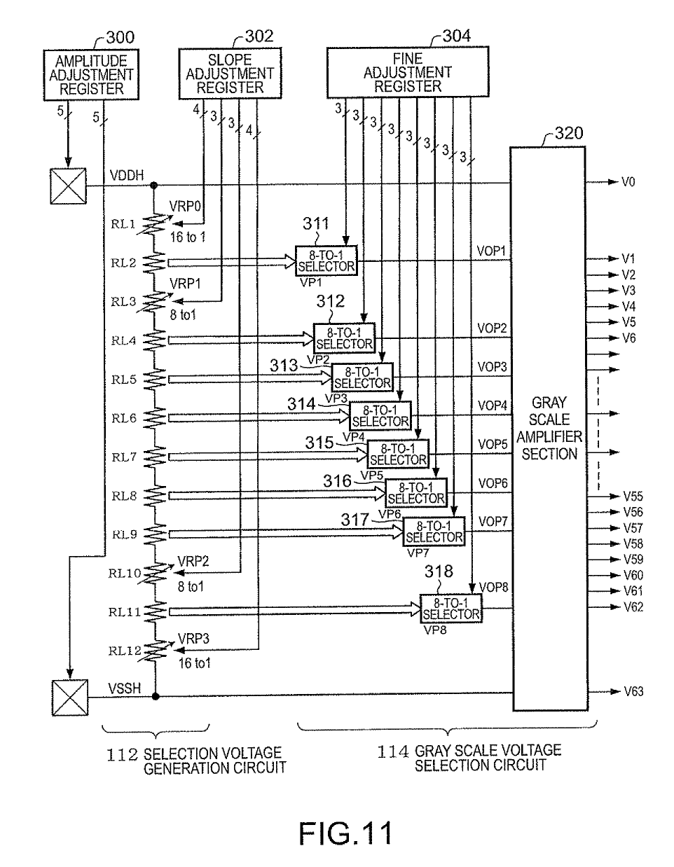

FIG. 11 shows a structural example of the gray scale voltage generation circuit 610 in FIG. 1. Adjustment data of a gray scale characteristic is set to an amplitude adjustment register 300, a slope adjustment register 302, and a fine adjustment register 304. The adjustment data is set (written) by the logic circuit 540 (the internal control circuit 547, and the control register 30). For example, setting adjustment data to the amplitude adjustment register 300 enables the amplitude of a gray scale voltage to be adjusted. Likewise, setting adjustment data to the slope adjustment register 302 enables the slope of a gray scale characteristic to be adjusted. Specifically, the resistance value of a resistance element RL12 included in a ladder resistor is changed based on adjustment data VRP3 of 4 bits set to the slope adjustment register 302. As a result, a slope adjustment can be conducted. VRP2 to VRP0 also serve in the same manner of VRP3. Setting adjustment data to the fine adjustment register 304 enables a gray scale characteristic to be fine-adjusted. Specifically, an 8-to-1 selector 318 selects one tap out of 8 taps of a resistance element RL11 based on adjustment data VP8 of 3 bits set to the fine adjustment register 304, and outputs the voltage of the selected tap as a VOP8. As a result, a gray scale characteristic can be fine-adjusted. VP7 to VP1 also serve in the same manner of VP8.

A gray scale amplifier section 320 outputs gray scale voltages V0 to V63 based on the outputs VOP1 to VOP8 of the 8-to-1 selectors 311 to 318, VDDH, and VSSH. Specifically, the gray scale amplifier section 320 includes a first to an eighth impedance converting circuits (operating amplifiers of a voltage follower connection) to which VOP1 to VPOP8 are inputted. The output voltages of adjacent impedance converting circuits in the first to the eighth impedance converting circuits are divided with resistors to generate the gray scale voltages V1 to V62.

One piece of gray scale characteristic data retained in the control register 30 may include a plurality of color components. In this case, adjustment data of the gray scale characteristic of one color component out of the plurality of color components is set to the amplitude adjustment register 300, the slope adjustment register 302, and fine adjustment register 304. Alternatively, one piece of gray scale characteristic data retained in the control register 30 may be directly set to the amplitude adjustment register 300, the slope adjustment register 302, and fine adjustment register 304.

The gray scale voltage generation circuit 610 in FIG. 1 may include a plurality of gray scale voltage generation circuit blocks each of which may be structured by the circuit shown in FIG. 11.

As the gray scale control parameters (gray scale characteristic data GCSET) stored in the EEPROM 134 (the control register 30), various kinds of parameters can be applicable. For example, in the embodiment, gray scale control parameters corresponding to a TFD method and the gray scale voltage generation circuit 610 may be employed.

The embodiment describes a case in which the invention is applied to a liquid crystal device using liquid crystal as an electro-optical material. The invention, however, can widely apply to electro-optical devices using an electro-optical effect. The devices include electroluminescence displays, fluorescent displays, plasma displays, and organic EL displays.

Those who skilled in the art will readily appreciate that the embodiments can be modified without departing the spirit of the invention (with reference to technical common sense in some cases). The scope of the invention includes all or part of the embodiments and modifications thereof, and defined by the appended claims and equivalent thereto.

1. An electronic apparatus, comprising:
an electro-optical panel having a plurality of scanning lines and a plurality of data lines;
an integrated circuit device controlling the electro-optical panel;
a first memory that stores a plurality of pieces of gray scale characteristic data for the electro-optical panel and is disposed outside the integrated circuit device; and
a processing section controlling the integrated circuit device and the first memory,
wherein the integrated circuit device includes:
a scanning driver driving the plurality of scanning lines;
a data driver driving the plurality of data lines;
a second memory storing a plurality of pieces of gray scale data;
a gray scale signal generation circuit generating a plurality of gray scale signals; and
a logic circuit controlling the scanning driver, the data driver, the second memory, and the gray scale signal generation circuit;
the logic circuit retrieves, at a power-on or a system reset, one of the plurality of pieces of gray scale characteristic data read out from the first memory as gray scale characteristic data for initial setting;
the logic circuit determines, at a request for given gray scale characteristic data, whether the gray scale characteristic data for initial setting retrieved in the logic circuit and the given gray scale characteristic data agree or not, and retrieves the given gray scale characteristic data out of the plurality of pieces of gray scale characteristic data read out from the first memory as gray scale characteristic date for rewriting so as to replace the gray scale characteristic data for initial setting with the gray scale characteristic data for rewriting in a case where the given gray scale characteristic data and the gray scale characteristic data for initial setting do not agree;
the gray scale signal generation circuit generates the plurality of gray scale signals based on gray scale characteristic data practically retrieved in the logic circuit; and
the data driver drives one of the plurality of data lines with one of the plurality of gray scale signals, and one of the plurality of pieces of gray scale data stored in the second memory corresponds to the one gray scale signal and the one data line.

2. The electronic apparatus according to claim 1, wherein:
the first memory stores a plurality of control parameters, and one of the plurality of control parameters corresponds to the plurality of pieces of gray scale characteristic data as a gray scale control parameter;
the logic circuit retrieves, at the power-on or the system reset, the plurality of control parameters read out from the first memory excluding the gray scale control parameter, and retrieves one of the plurality of pieces of gray scale characteristic data read out from the first memory as gray scale characteristic data for initial setting; and
the logic circuit retrieves, at a request for given refreshing, the plurality of control parameters read out from the first memory excluding the gray scale control parameter, and retrieves one of the plurality of pieces of gray scale characteristic data read out from the first memory as gray scale characteristic data for refreshing, the gray scale characteristic data for refreshing corresponding to the gray scale characteristic data actually retrieved in the logic circuit.

3. An integrated circuit device, comprising:
a control register capable of retaining data; and
an internal control circuit that acknowledges an instruction from a processing section and controls writing data into the control register;
wherein: the internal control circuit writes, at a power-on or a system reset, one of a plurality of pieces of gray scale characteristic data read out from a memory into the control register as gray scale characteristic data for initial setting; and
the internal circuit determines, at a request for given gray scale characteristic data, whether the gray scale characteristic data for the initial setting written into the control register and the given gray scale characteristic data agree or not, and writes the given gray scale characteristic data out of the plurality of pieces of gray scale characteristic data read out from the memory into the control register as gray scale characteristic date for rewriting so as to replace the gray scale characteristic data for initial setting with the gray scale characteristic data for rewriting in a case where the given gray scale characteristic data and the gray scale characteristic data for initial setting do not agree.

4. The integrated circuit device according to claim 3, wherein the internal control circuit does not write the given gray scale characteristic data into the control register as gray scale characteristic date for rewriting in a case where the given gray scale characteristic data and the gray scale characteristic data for initial setting agree.

5. The integrated circuit device according to claim 3, wherein the internal circuit determines, at a request for second given gray scale characteristic data, whether the gray scale characteristic data practically written in the control register and the second given gray scale characteristic data agree or not, and writes the second given gray scale characteristic data out of the plurality of pieces of gray scale characteristic data read out from the memory into the control register as the gray scale characteristic date for rewriting so as to replace the gray scale characteristic data practically written with the gray scale characteristic data for rewriting in a case where the second given gray scale characteristic data and the gray scale characteristic data practically written do not agree.

6. The integrated circuit device according to claim 3, wherein:
the memory stores a plurality of control parameters, and one of the plurality of control parameters corresponds to the plurality of pieces of gray scale characteristic data as a gray scale control parameter;
the internal control circuit writes, at the power-on or the system reset, the plurality of control parameters read out from the memory excluding the gray scale control parameter into the control register, and writes one of the plurality of pieces of gray scale characteristic data read out from the memory into the control register as gray scale characteristic data for initial setting; and
the internal control circuit writes, at a request for given refreshing, the plurality of control parameters read out from the memory excluding the gray scale control parameter into the control register, and writes one of the plurality of pieces of gray scale characteristic data read out from the memory into the control register as gray scale characteristic data for refreshing, the gray scale characteristic data for refreshing corresponding to the gray scale characteristic data practically written into the control register.

7. The integrated circuit device according to claim 3, wherein:
the integrated circuit device drives an electro-optical panel based on the gray scale characteristic data practically written into the control register; and
the internal control circuit starts, at the request for given gray scale characteristic data, writing the given gray scale characteristic data in a non-display period of the electro-optical panel.

8. The integrated circuit device according to claim 6, wherein:
the integrated circuit device drives an electro-optical panel based on the gray scale characteristic data practically written into the control register; and
the internal control circuit starts, at the request for given refreshing, writing the plurality of control parameters in a non-display period of the electro-optical panel.

9. The integrated circuit device according to claim 8, wherein, in a case where the request for gray scale characteristic data conflicts with the request for given refreshing, the internal control circuit gives a higher priority to the request for given gray scale characteristic data than to the request for given refreshing, and starts writing the given gray scale characteristic data in the non-display period of the electro-optical panel.

10. The integrated circuit device according to claim 9, further comprising a command register capable of retaining an instruction from the processing section, wherein:
the internal control circuit, at the request for given gray scale characteristic data, stores, in a first corresponding region in the command register, a memory that the request for given gray scale characteristic data has been inputted;
the internal control circuit, at the request for given refreshing, stores, in a second corresponding region in the command register, a memory that the request for given refreshing has been inputted; and
the internal control circuit acknowledges that the request for given gray scale characteristic data conflicts with the request for given refreshing in accordance with the memories in the first and the second corresponding regions.

11. The integrated circuit device according to claim 3, wherein each of the plurality of pieces of gray scale characteristic data stored in the memory has a plurality of color components.

12. A method for setting gray scale characteristic data, comprising:
writing, into a control register in a first mode, a first piece of gray scale characteristic data selected from a plurality of pieces of gray scale characteristic data stored in a memory; and
writing, into the control register in a second mode, a second piece of gray scale characteristic data selected from the plurality of pieces of gray scale characteristic data stored in the memory so as to replace the first piece of gray scale characteristic data with the second piece of gray scale characteristic data.
